(19) United States
(12) Patent Application Publication
(10) Pub. No.: US 2015/0042131 A1
(43) Pub. Date: Feb. 12, 2015

(54) ALL-IN-ONE ENTERTAINMENT CAR SEAT

(71) Applicant: Rebecca Haas, Somerville, TX (US)

(72) Inventor: Rebecca Haas, Somerville, TX (US)

(21) Appl. No.: 13/959,967

(22) Filed: Aug. 6, 2013

(51) Int. Cl. B60N 2/28; H04N 21/432; H04N 5/93

(52) U.S. Cl. CPC B60N 2/28; H04N 5/93; H04N 21/4325
USPC 297/183.1

(57) ABSTRACT

An all-in-one entertainment car seat comprising a car seat, where the car seat includes a seat, a backrest, a base and a handle, and where the car seat supports a child user; a pair of side supports attached to the backrest, where the pair of side supports extend from the backrest to in front of the seat; a media device positioned between the pair of side supports in front of the child user seated in the car seat, where the media device includes a screen on a front face, and where the media device plays a plurality of media options; a power cord to power the media device, where the power cord plugs into a cigarette lighter socket; and a controller to control the plurality of media options.

### BACKGROUND OF THE INVENTION

1. Field of the Invention

The present invention relates to a car seat for an infant or child that includes a variety of comfort and entertainment capabilities to keep the child stimulated while seated in the seat.

2. Description of Related Art

Car seats are required fixtures in a vehicle transporting infants and small children. Babies must be secured in a car seat during travel otherwise the parents risks getting a ticket which may result in paying a fee or even points on the driver's license. The car seats maintain the infant in a safe position to ensure that in case of emergency the child is protected. The car seats are attached to a vehicle seat with seatbelts and straps to prevent the shifting and sliding during use. To secure the child within the car seat harnesses, headrests, side supports and locks are utilized so that the child's body remains in place.

With all of the safety features some car seats include entertaining features to occupy the baby while seated. For example, toys or noise maker may be attached to the handle to hang in front of the baby's face allowing them to hit and pull the toys. Further the car seats may have a tray upon which toys may be attached. Alternatively, some parents attach video monitors to the backside of their headrests for the child to watch movies. Many vehicle manufacturers are now incorporating the monitors directly into the headrests with controls in the front dash.

While the toys and monitors are fun for the child, it would be beneficial in the art to provide a car seat that includes both of these features on a single device. It would also be desirable in the art to provide an entertainment device for a car seat that is also interactive to occupy and distract the child while they ride in a vehicle.

### SUMMARY OF THE INVENTION

In view of the foregoing disadvantages inherent in the prior art, the general purpose of the present invention is to provide an entertainment device for a car seat, configured to include all of the advantages of the prior art, and to overcome the drawbacks inherent therein.

Accordingly, an object of the present invention is to provide a car seat with an interactive entertainment device to entertain an infant positioned in the seat.

Another object of the present invention is to provide a car seat with comfort features in the seat for an enjoyable ride for the infant user.

To achieve the above objects, in an aspect of the present invention, an all-in-one entertainment car seat is described comprising a car seat, where the car seat includes a seat, a backrest, a base and a handle, and where the car seat supports a child user; a pair of side supports attached to the backrest, where the pair of side supports extend from the backrest to in front of the seat; a media device positioned between the pair of side supports in front of the child user seated in the car seat, where the media device includes a screen on a front face, and where the media device plays a plurality of media options; a power cord to power the media device, where the power cord plugs into a cigarette lighter socket; and a controller to control the plurality of media options.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an all-in-one entertainment car seat in accordance with an exemplary embodiment of the present invention;

FIG. 2 depicts a front face (A) and a back face (B) of a media device in accordance with an exemplary embodiment of the present invention; and

FIG. 3 depicts a front view of a controller in accordance with an exemplary embodiment of the present invention.

Like reference numerals refer to like parts throughout the description of several views of the drawings.

### DETAILED DESCRIPTION OF THE DRAWINGS

The present invention relates to a car seat for an infant or child that includes a variety of comfort and entertainment capabilities to keep the child stimulated while seated in the seat. The present invention provides an all-in-one entertainment car seat which utilizes an array of stimulating and educational entertainment options for a child user. The all-in-one entertainment car seat provides all the required safety features but also includes additional comfort features like a vibrating base and massaging backrest. The entertainment features of the all-in-one entertainment car seat include a media device capable of playing CD/DVDs, educational games, and recording personal voice messages for immediate or postponed playback. With the all-in-one entertainment car seat the child user is never bored while still being protected during transport.

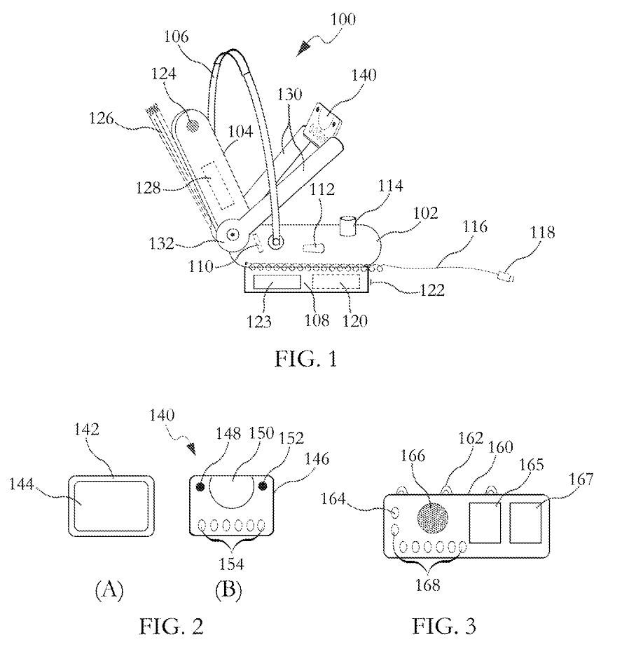

Turning now descriptively to the drawings, referring to FIG. 1, a perspective view of an all-in-one entertainment car seat 100 is shown in accordance with an exemplary embodiment of the present invention. The all-in-one entertainment car seat 100 is composed of two main structures, a seat 102 and a backrest 104. The seat 102 includes a handle 106 that arcs over the seat 102 and backrest 104 to allow a user to carry the all-in-one entertainment car seat 100. The handle 106 may include a comfort grip handle for comfort against the user's hand. The seat 102 rests upon a base 108 which is positioned on a vehicle seat. The base 108 provides the balance and stability for the seat 102 while in the vehicle cabin.

The seat 102 includes a plurality of features for both safety and comfort. The seat 102 may include a seatbelt opening 110 through which a seatbelt is threaded to secure the base 108 to the vehicle seat. The seat 102 further includes a recliner handle 112 on the side of the seat 102 to activate a reclining mechanism within the seat 102 and backrest 104. Finally, a cup holder 114 is positioned along the lateral portion of the seat 102.

Within the base 108 may be a vibrating mechanism 120 which vibrates the entire all-in-one car seat 100 to sooth and comfort the infant. The vibrating mechanism 120 may include an activation button 122 to power the mechanism 120 on and off. The base 108 may also include a drawer 123 to store miscellaneous items for the user. The drawer 123 pulls out from the base 108 and then conveniently slides back to clear any additional toys the child may want. Attached to the base 108 may be a power cord 116 to power the all-in-one car seat 100. The power cord 116 may be retractable with a car charger plug 118 to enable the user to plug the power cord 116 into the vehicle's cigarette lighter socket for power.

The backrest 104 may include a set of speakers 124 positioned at a top portion. The speakers 124 play audio sounds from music, movies, voices and games. On a backside of the backrest 104 may be an accordion-style sunshade 126. The sunshade 126 pulls forward from the back of the backrest 104 to shield the child from the sun coming into the cabin. Within the backrest 104 may be a massager 128 which rubs and comforts the child. The massager 128 may include adjustable settings to increase and decrease the amount of pressure exerted against the child's back.

Extending from the backrest 104 to the front of the seat 102 may be a pair of side supports 130. The side supports 130 are adjustable around a pair of pivots 132 positioned on each side of the lower portion of the backrest 104. The side supports 130 may be used as armrests for the child to rest their arms during use. The side supports 130 may be covered in a soft foam material for additional cushioning. Finally, between the side supports 130 may be a media device 140. The media device 140 provides a plurality of different entertainment features for the child while riding in the vehicle.

Referring now to FIG. 2, a front face 142 (FIG. 2A) and a back face 146 (FIG. 2B) of a media device are illustrated accordance with an exemplary embodiment of the present invention. The front face 142 includes a screen 144 to project movie and games images from the media device 140. The screen 144 may be a touch screen to allow the child to control the media device 140 by simply touching the screen.

The back face 146 includes an activation button 148 to power the media device 140. The media device 140 may place CDs or DVDs which are inserted into a CD/DVD receiver 150. The CD/DVD receiver 150 includes an open/close button to enable the user to insert the CDs and DVDs into the media device 140. A plurality of control buttons 154 are positioned along the media device 140 to select what is seen on the screen 144. The control buttons 154 may include media selection buttons to choose between playing music, movies, books or games; control buttons for play, stop, fast forward and rewind; game selection buttons for alphabet, shape, number, and animal games; and record and play buttons for the user to record voices into a memory storage unit within the media device.

Finally, referring to FIG. 3 a front view of a controller 160 is shown in accordance with an exemplary embodiment of the present invention. The controller 160 is the mechanism by which the user may control the media device 140. The controller 160 may be attached to the dash of the vehicle for easy access by the user. Alternatively, the controller 160 may be fastened to a sun visor above the user's head. The controller 160 may include a set of attachment means 162 to secure the controller 160 to either the dash or the visor. The attachment means 162 may be hook and loop fasteners (commonly known as Velcro®). The attachment means 162 may also be a set of hooks.

The controller 160 may include a power button 164 to power the media device 140. The controller 160 may include a speaker 166 for the user to hear what is playing on the media device. The user may also speak into the speaker 166 to project their voice into the speakers 124 within the backrest 104 of the all-in-one entertainment car seat 100. A dual monitors 165, 167 may be positioned on the controller 160 to allow the user to see what movies or games the child is playing and view the child in the seat 100. A plurality of control buttons 168 are positioned on the controller 160 to allow the user to activate the CDs, DVDs, games and books played on the media device 140. The control buttons 168 may include the same features as the control buttons 154 on the media device 140 including the media selection buttons to choose between playing music, movies, books or games; control buttons for play, stop, fast forward and rewind; game selection buttons for alphabet, shape, number, and animal games; and record and play buttons for the user to record voices into a memory storage unit within the media device.

With the all-in-one entertainment car seat 100 the child is provided an engaging interactive experience. The child receives audio, video and physical stimulation while riding in the vehicle. The user is provided the comfort of mind that their child is being entertained while also safely resting within a state of the art car seat.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An all-in-one entertainment car seat comprising:
a. a car seat, where the car seat includes a seat, a backrest, a base and a handle, and where the car seat supports a child user;
b. a pair of side supports attached to the backrest, where the pair of side supports extend from the backrest to in front of the seat;
c. a media device positioned between the pair of side supports in front of the child user seated in the car seat, where the media device includes a screen on a front face, and where the media device plays a plurality of media options;
d. a power cord to power the media device, where the power cord plugs into a cigarette lighter socket; and
e. a controller to control the plurality of media options.

2. The all-in-one entertainment car seat according to claim 1, where the base of the car seat includes a vibrating mechanism with an activation button.

3. The all-in-one entertainment car seat according to claim 1, where the base of the car seat includes a drawer for storage.

4. The all-in-one entertainment car seat according to claim 1, where the backrest includes a sunshade.

5. The all-in-one entertainment car seat according to claim 1, where the backrest includes a massager.

6. The all-in-one entertainment car seat according to claim 1, where the backrest includes a pair of speakers at a top portion of the backrest.

7. The all-in-one entertainment car seat according to claim 1, where the seat includes a recliner handle to recline the backrest from the seat.

8. The all-in-one entertainment car seat according to claim 1, where the seat includes a cup holder.

9. The all-in-one entertainment car seat according to claim 1, where the plurality of media options played in the media device includes CDs, DVDs, books and games.

10. The all-in-one entertainment car seat according to claim 9, where the media device includes a plurality of buttons control the plurality of media options associated with the media device.

11. The all-in-one entertainment car seat according to claim 10, where the plurality of buttons control a plurality of functions on the media device, where the plurality of functions include media selection buttons to choose between playing music, movies, books or games; control buttons for play, stop, fast forward and rewind; game selection buttons for alphabet, shape, number, and animal games; and record and play buttons for the user to record voices into a memory storage unit within the media device.

12. The all-in-one entertainment car seat according to claim 1, where the media device is able to record and play voices.

13. The all-in-one entertainment car seat according to claim 1, where the controller includes a plurality of buttons.

14. The all-in-one entertainment car seat according to claim 13, where the plurality of buttons control a plurality of functions on the media device, where the plurality of functions include media selection buttons to choose between playing music, movies, books or games; control buttons for play, stop, fast forward and rewind; game selection buttons for alphabet, shape, number, and animal games; and record and play buttons for the user to record voices into a memory storage unit within the media device.

15. The all-in-one entertainment car seat according to claim 1, where the controller includes a speaker and a monitor.

16. The all-in-one entertainment car seat according to claim 1, where the controller includes a set of attachment means to fasten the controller to one of at least a dash or a sun visor.

17. The all-in-one entertainment car seat according to claim 16, where the set of attachment means is hook and loop fasteners.

18. The all-in-one entertainment car seat according to claim 1, where the set of attachment means is a set of hooks.
